(19) United States
(12) Patent Application Publication
(10) Pub. No.: US 2013/0148218 A1
(43) Pub. Date: Jun. 13, 2013

(54) SWING ARM VEHICLE MIRROR SYSTEM

(71) Applicant: William P. Schmidt, Newport, MI (US)

(72) Inventor: William P. Schmidt, Newport, MI (US)

(21) Appl. No.: 13/315,675

(22) Filed: Dec. 9, 2011

(51) Int. Cl. B60R 1/074; B60R 1/078

(52) U.S. Cl. 359/841

(57) ABSTRACT

A mirror imaging system for military vehicles such as Humvees. Mirror assemblies with preferred convex and/or ellipsoidal lens members are positioned outside the front and sides of the vehicles to provide extended fields of view around the vehicles. The mirror assemblies have spring actuated rotation mechanisms which allow the mirror assemblies to be rotated from their deployed positions due to intentional or accidental contact, or for storage or transport. The mounting assemblies can be angled to allow the mirrors to be positioned more closely adjacent the surface of the hood of the vehicle. The mirror assemblies can be rotated manually, or rotated remotely with an electronic actuation system. Mounting mechanisms for the mirror assemblies can be attached to the hood hinge members which are located at the front of the vehicle.

### TECHNICAL FIELD

A mirror imaging system for military vehicles, particularly a mirror system which allows drivers to see formerly blind areas in front and along the sides of the vehicles, and also can rotate (breakaway) if hit and for storage and transport.

### BACKGROUND

It is well known today that military vehicles, such as Humvees, are exposed to great risks in various military situations. (“Humvee” means “High-Mobility Multipurpose Wheeled Vehicle.”) For example, in Iraq and Afghanistan at this time, Humvees and other U.S. military vehicles have been attacked with IEDs (Improvised Explosive Devices). In addition, vehicles such as Humvees often are required to travel through narrow areas, such as city streets, where the room for passage is very tight. It would be advantageous to these vehicles to have imaging systems, such as mirrors, which can provide viewing along the front and the sides of the military vehicles which presently cannot be seen by the driver. These are areas which are not covered within the reflection areas of rear view mirrors which are positioned along the sides of a vehicle. The areas along the front of the vehicles and immediately along the sides are also areas in which IEDs are often located.

It also would be advantageous if the imaging systems could be positioned on locations of the vehicle where, if they are projecting outside the sides of the vehicle, be allowed to “breakaway” if hit or struck by another vehicle, building, or the like. It also would be advantageous if the imaging systems could be rotated and/or folded so that the mirrors and mounting arms are positioned close to the vehicle for storage or transport, and so they would not obstruct the view of the driver if the vehicle were driven with the imaging systems in the stored positions.

It further would be advantageous if the imaging systems could be moved from their deployed to their storage positions and vice versa electronically (remotely) so that the persons in the vehicles could perform this without leaving the vehicle.

It further would be advantageous if the imaging system were able to be installed on the vehicles in an easy and inexpensive manner, and able to be easily retrofitted on existing vehicles.

### SUMMARY OF THE INVENTION

The present invention provides mirror imaging systems for military vehicles, such as Humvees, which meet the above objectives. The imaging systems preferably provide a pair of mirror assemblies which are secured to mounting members and (1) that can be installed on the front of the vehicles in a quick and easy manner, (2) that provide views of the blind spots in front and along the sides of the vehicle to the driver, (3) that can be easily moved between their deployed and stored positions, such as remotely, and (4) can be stored in a manner which provides minimal obstructions to the driver of the vehicle.

The mirror assemblies have mirror lenses which are preferably concave and/or ellipsoidal and provide fields of view much larger than conventional rearview mirrors, or mirrors which are planar or only slightly rounded. When positioned on the front of the military vehicles, these mirror systems provide images of the blind spots along the sides of the vehicles as well as in front of the vehicles and also provide fields of view for a considerable distance in various directions around the vehicles. This increases the safety to the vehicles and their occupants.

The mirror assemblies are positioned on mounting assemblies which are attached to locations on the most forward part of the vehicles. In vehicles, such as Humvees, in which the front hood is hinged forward of the front wheels for access to the engine compartment, the mounting assemblies can be secured in the same position as the hood hinges. This allows the mounting assemblies to be retrofitted and attached to the vehicles in a easy manner, without the need for additional openings or holes to be made in the vehicle. The mirror assemblies can be positioned forward of the front of the vehicles to provide even better and wider fields of view.

The mounting assemblies for the mirror assemblies are preferably attached to the vehicles with a spring activated rotational-type ratcheting mounting mechanisms. The mounting mechanisms allow the mounting assemblies, as well as the mirror assemblies, to breakaway and be rotated inwardly within the confines of the sides of the vehicle if struck by a building, another vehicle, or the like. The rotational-type mounting mechanism also allows the mirror assemblies to be manually rotated out of the way (i.e. next to the vehicle) for storage and/or transport of the vehicle. This procedure could be carried out remotely with an electronically actuated system. In addition, the mounting arms are configured to provide minimal obstructions to the view of the driver when the imaging systems are positioned in their stored positions.

Further features, benefits and advantages of the inventive process and system will become apparent from the following description of embodiments of the invention, particularly when viewed in combination with the accompanying drawings and appended claims.

### BRIEF DESCRIPTION OF THE DRAWINGS

FIG. 1 is a perspective drawing depicting an embodiment of the mirror imaging systems on a military vehicle.

FIG. 2 is a front view of the vehicle shown in FIG. 1.

FIGS. 3A and 3B illustrate a pair of mirror imaging systems (top view) for use on a vehicle, such as that shown in FIGS. 1 and 2.

FIGS. 4A and 4B are front views of the mirror imaging system shown in FIGS. 3A and 3B.

FIG. 5A illustrates a breakaway mounting mechanism for the mirror imaging systems shown in FIGS. 1-4.

FIG. 5B is an exploded view of a breakaway mechanism as shown in FIG. 5A.

FIG. 6 depicts the rotation of the mirror imaging systems between their deployed and storage (or breakaway) positions.

FIG. 7 is a side view of the front of the vehicle as shown in FIGS. 1 and 2.

FIG. 8 illustrates mounting of a mirror assembly on a mounting system embodiment.

FIGS. 9A and 9B are front and side views illustrating the preferred mounting of a mirror imaging system on a vehicle.

FIGS. 10 and 11 are enlarged front and side views, respectively, of a hood hinge member.

FIG. 12 illustrates a final mounting of a mirror imaging system on a vehicle.

FIG. 13 illustrates the rotation of the hood of a vehicle around hinges on the front of the vehicle.

FIGS. 14A and 14B show an alternate form of mirror assemblies which can be used with a mirror imaging system.

FIGS. 15A and 15B showing still another embodiment of mirror assemblies which can be used with a mirror imaging system.

FIG. 16 illustrates the wide field of view provided to a vehicle using a mirror imaging system.

FIG. 17 depicts an embodiment of an electromechanical system for rotation of the imaging systems on a vehicle.

FIG. 18 schematically depicts a portion of the blind spot of a drivers in a Humvee or similar vehicle.

FIG. 19 illustrates an alternate embodiment of the invention.

FIG. 20 is a side view of the vehicle and imaging system shown in FIG. 19.

### DESCRIPTION OF THE PREFERRED EMBODIMENTS

The present invention is particularly designed to be used with a military vehicle 20, such as a Humvee as shown in the drawings. (“Humvee” means “High-Mobility Multipurpose Wheeled Vehicle.”) Preferred embodiments of the invention are described herein, but it is to be understood that the invention is not limited just to these embodiments. The invention includes all embodiments falling within the scope of the claims.

A mirror imaging system 22 includes a pair of mirror assemblies 26 and 28 which are attached to the vehicle 20 in a manner to be described below. The mirror assemblies 26, 28 are used when the vehicle is being driven as well as when it is stationary. The mirror assemblies 26 and 28 are supported by mounting members 30 and 32, respectively. The mounting members are attached to the vehicle 20 by mounting mechanisms 36 and 38.

The mounting mechanisms 36 and 38 are attached to the vehicle at the same location as hinge mechanisms 42 and 44. The hinge mechanisms are used to allow the hood member 46 of the vehicle 20 to rotate and open up for access to the engine compartment.

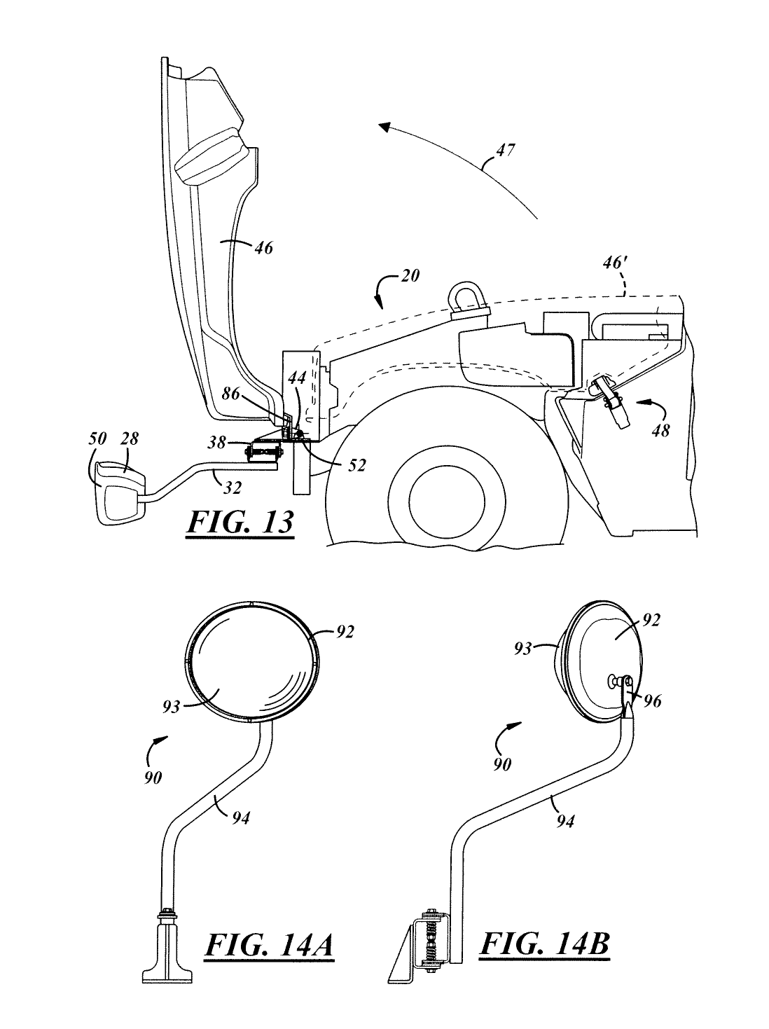

The rotation of the hood member 46 around the hinge mechanisms is shown in FIG. 13. The hood member 46 is rotated from its rest position (as shown in other figures) in the direction of the arrow 47. The rest position is indicated by the reference numeral 46′ in FIG. 13.

The mounting members 30 and 32 are preferably shaped and configured so that they allow the mirror assemblies 26, 28 to be positioned in their deployed positions at a location in front of and beside the vehicles to provide maximum view of the former blind spots, and yet at the same time minimize any direct obstructions to the field of view of the drivers. Also, the mounting members 30 and 32 can be shaped and configured to allow them to be positioned in their storage positions adjacent the shape and configuration of the surface of the hood of the vehicle in order to further minimize the amount of direct obstruction of the view of the vehicle driver when the imaging systems are in their stored positions.

The hinge mechanisms 42 and 44 are positioned on hinge support members 50 and 52. The hinge support members 50 and 52 are attached to, or part of, the frame of the vehicle 20. As shown in FIG. 13, the hood member rotates and opens up in a direction which is the opposite of most automobiles. In order to allow sufficient access to the engine and other components and accessories in the engine compartment, the hood is hinged at the front of the vehicle.

The hood member 46 is held in its closed position covering the engine compartment by securing or latching mechanisms 48. Although not shown, hood securing mechanisms are positioned on each side of the vehicle 20.

The two mirror assemblies 26 and 28 are preferably the same in size and shape, as well as providing the same fields of view. Thus they will be described in the same manner. Each of the mirror assemblies has a housing 50 and a mirror lens member 52. A sealing member, such as an elastomeric ring member, can be positioned around the intersection or joint between the housing 50 and mirror lens 52 in order to seal the inside of the mirror mechanism from the outside environment.

The housing 50 can be of any durable material, but preferably is made of a molded plastic material. Similarly, the mirror lens can be made of any material, but preferably is made from a molded plastic material that has a mirrored finish on the outside surface thereof.

The mirror assemblies preferably have lenses which are oval and convex or ellipsoidal in shape. Examples of such mirror assemblies which can be used with the invention are those depicted in U.S. Pat. No. 5,589,984. Mirrors with other convex lenses could also be used, such as those depicted in U.S. Pat. No. 4,436,372.

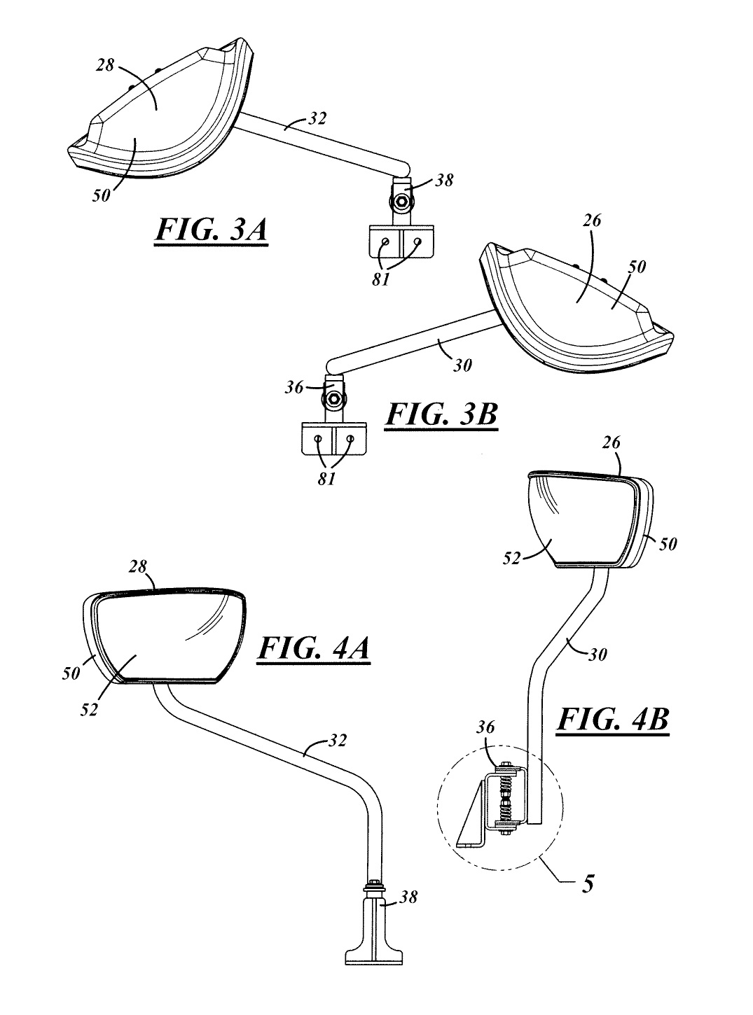

Mounting members 30 and 32 are best shown in FIGS. 3A-3B and 4A-4B. The mounting members shown in FIGS. 3A and 4A are configured to be attached at the front left of the vehicle, while the mounting mechanisms shown in FIGS. 3B and 4B are attached at the front right of the vehicle. Each of the mounting members is preferably a piece of metal tubing which has been shaped in one or more of the configurations shown in the drawings, and preferably is made from a steel material.

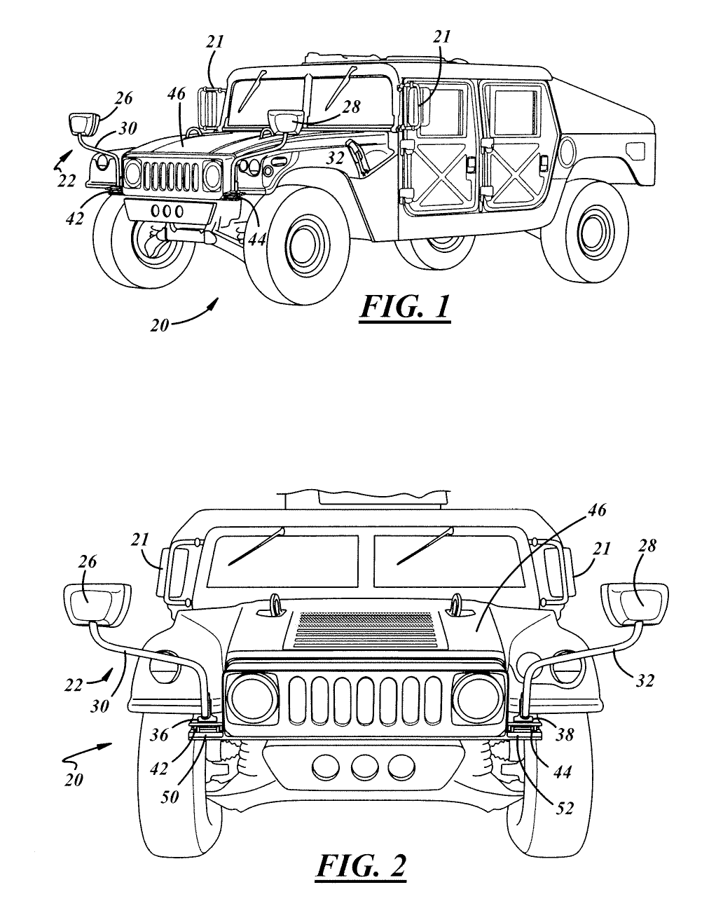

The mirror assemblies 26 and 28 of the type shown in FIGS. 1-7 can be attached and connected to the mounting members in the manner shown in FIG. 8. This is a preferred, but not exclusive, manner of attachment. The mounting members are positioned through openings 54 in the housings 50 and then secured to the housing in the appropriate imaging position. The mounting members can be attached by an internal plate member (not shown) and a plurality of fasteners 56. The fasteners can be any type of conventional fasteners, such as screws.

Due to the expected use of the mirror image system in accordance with the present invention, the mirror assemblies should be secured very tightly on the mounting members once they are positioned appropriately to provide the largest viewing area for the driver of the vehicle. It is also significant that due to the mounting of the imaging systems on the front hinges of the vehicles, the mirror assemblies can be positioned to extend forwardly ahead of the vehicles. This provides even a better field of view for the drivers.

The mounting mechanisms 36 and 38 for the two mounting members 30 and 32 and the two mirror assemblies 26 and 28, respectively, are preferably the same. Thus, only one will be described with the description being equally applicable to the mounting mechanisms for each side of the vehicle.

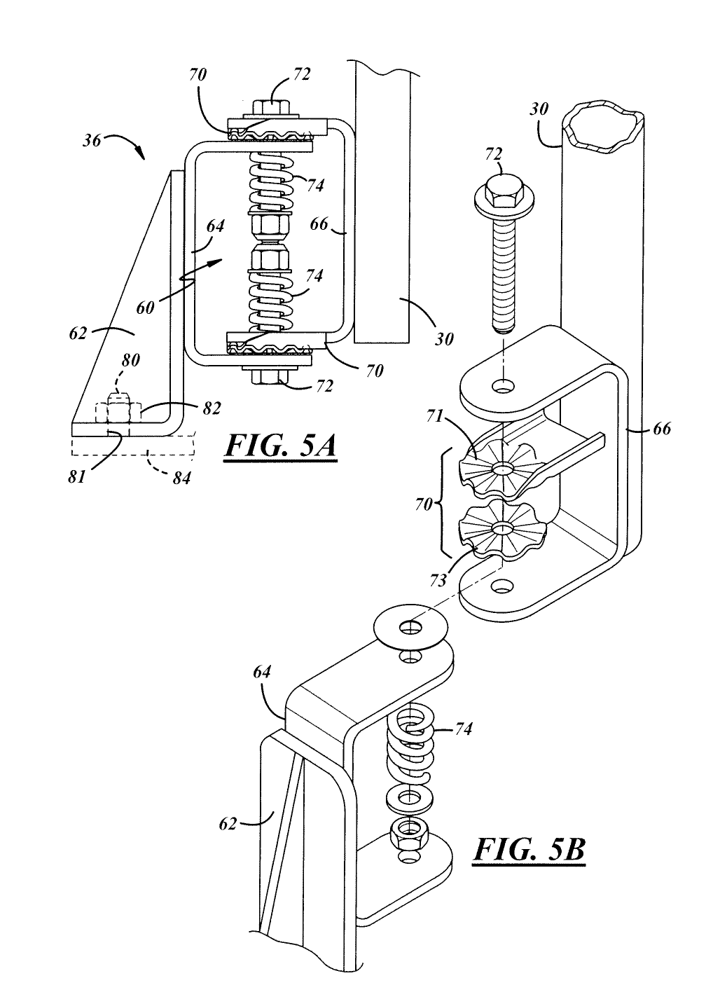

As shown in FIGS. 5A and 5B, the mounting mechanisms include spring activated rotation-type ratcheting mechanisms 60. The rotation mechanism is positioned between U-shaped bracket members 64 and 66 and attached to mounting bracket member 62. The bracket member 62 can be attached to U-shaped bracket member 64 in any conventional manner, such as by welding.

Similarly, U-shaped bracket members 66 are attached to the mounting member 30, 32 in any conventional manner, such as by welding. The spring activated rotation mechanism 60 includes two ratcheting mechanisms 70 along with two large bolt members 72 and two coil spring members 74. (FIG. 5B only shows one of the ratcheting mechanisms, but the other is the same.)

An exploded view of a preferred spring actuated rotation mechanism 60 is shown in FIG. 5B. The mechanism includes two mating wavy (scalloped) members 71 and 73. In their rest positions, the two wavy members are forced closely together by the force of the coil springs 74. Rotation of the mounting members 30, 32 and/or the U-shaped bracket member 66, forces compression of the coil spring 74 and allows the imaging system to be rotated to any of several desired positions. Preferably, stop members (not shown) are utilized to restrict rotation or movement of the imaging systems only to positions between the deployed and stored positions.

The spring actuator rotation mechanism 60 can be of any conventional type, such as the type shown in U.S. Pat. No. 3,730,474, or one that is available from ReTrac Mirrors, Brandon, S. D. Also, although two mechanisms 70 are shown in the drawings, it is possible in another embodiment to only utilize one mechanism 70 in each mechanism 60 and simply provide a rotating pivot member in place of the other one.

The bracket members 62 have a pair of openings 81, as shown in FIGS. 3A and 3B. The fasteners 82, such as nuts, are used to attach the mounting bracket 62 to projecting threaded fastener members 80 attached to the hinge mechanisms 42, 44.

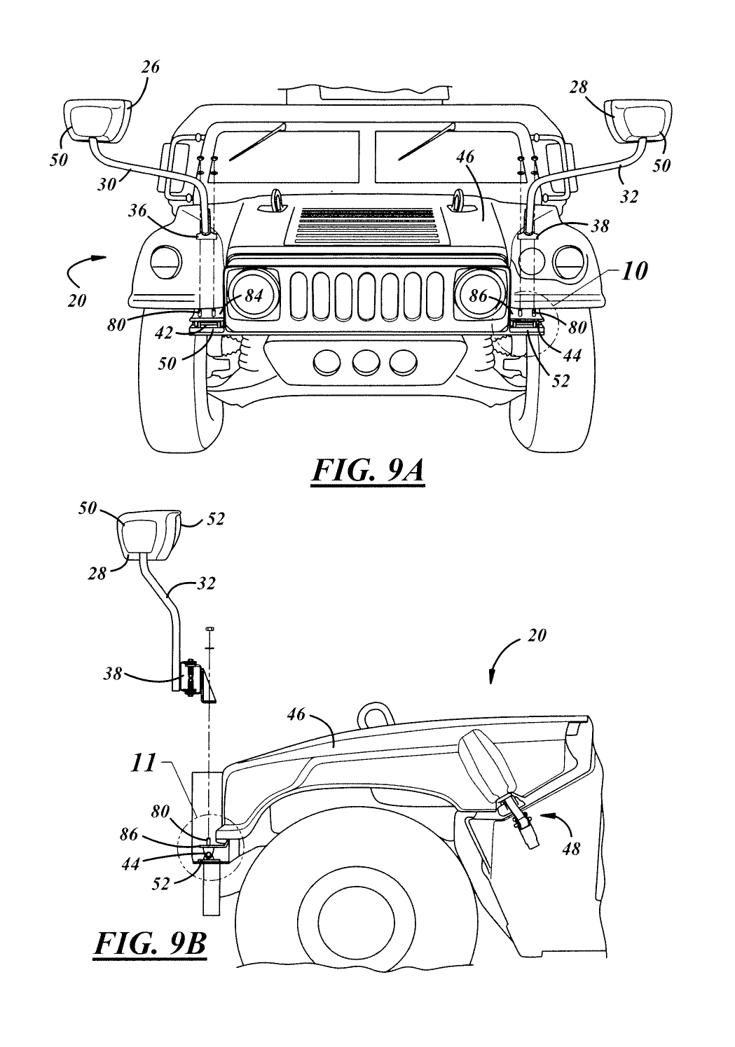

The installations and assembly of the mounting mechanisms 36, 38 to the hinge mechanism 42 and 44 is shown in particular in FIGS. 9A and 9B. The two projecting threaded fasteners 80 (also called “posts”) which are attached to or part of the hinge mechanisms 42, 44, protrude through flanges 82, 84 on the front of the vehicle 20. The openings 81 in bracket members 62 are provided for posts 80 to come through them and be secured in place by bolts 82 or other fasteners.

With the present invention, new holes or mounting systems do not need to be provided on the vehicle 20 or flanges 82, 84 in order to mount the mirror imaging system on the vehicle. The openings 81 in the bracket members 62 line up and mate with the threaded fasteners (posts) 80. In order to install the mirror imaging system in accordance with the present invention, the nuts or other fasteners which are attached to posts or threaded fastener members 80 are removed and the bracket member 62 is positioned over the posts 80. Then, nut members 82 or the like are attached to the members 80 holding the bracket members 62 in place. This in turn holds the mounting mechanisms 36, 38, mounting members 32, 34, and mirror assemblies 26, 28 in place on the vehicle 20. Other systems for rigidly securing the brackets 62 to the hinge mechanisms could be used, such as lock nuts, or even spot welding.

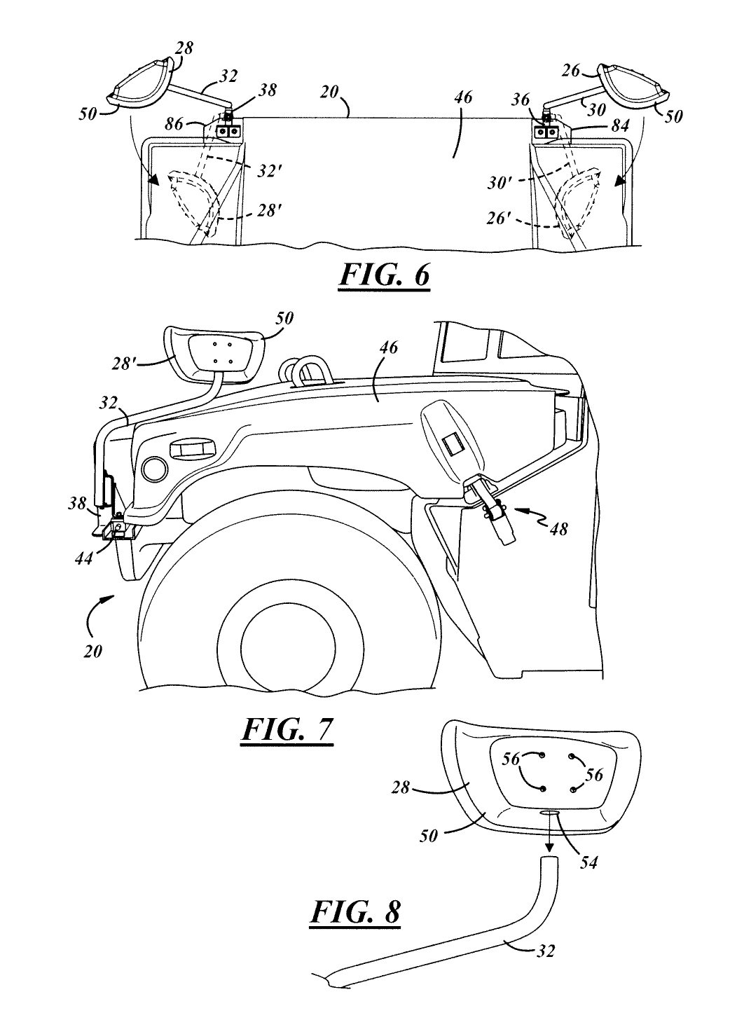

The spring activated rotation mechanisms 60 attached to the mounting members 30 and 32 allow the mounting members and mirror assemblies 26 and 28 to rotate. The mirror assemblies 26 and 28 are shown in their deployed positions in FIGS. 1 and 2. The rotation mechanisms 60 allow the mirror assemblies to be rotated from their deployed positions to their storage positions 26′ and 28′ as shown in FIGS. 6 and 7. The mirror assemblies can be manually rotated to positions 26′ and 28′ for storage or transport of the vehicle.

The spring actuated rotation mechanism 60 also allow the mirror assemblies 26 and 28 to be moved to their stored positions if they are hit or struck in some manner such as if the vehicle hits or is hit by another vehicle, a corner of a building or the like. This allows the mirror assemblies to rotate, and be prevented from being destroyed or significantly damaged.

The precise type of mounting mechanisms 36, 38 as shown in the drawings is only a preferred type of mounting mechanism and is not meant to be limiting. Other mounting mechanisms known to persons skilled in the art could be utilized in place of the mounting mechanisms 36, 38. Similarly, the spring actuated rotation mechanisms 60 are the preferred embodiments of mechanisms which allow the mounting members and attached mirror assemblies to rotate from deployed positions to stored positions whether rotated intentionally or unintentionally. Other types of rotation mechanisms, known to persons of ordinary skill in the art, spring actuated or not, could be utilized.

The rotation of the imaging systems between their stored and deployed positions, or possibly at positions therebetween which are possible with the ratchet-type spring-activated rotation mechanism, is typically carried out manually. However, in another embodiment of the invention, a remotely activated electromechanical system could be used to rotate the imaging systems between their deployed and stored positions. This allows the position of the imaging system to be safely changed remotely by the driver of the vehicle from inside the vehicle.

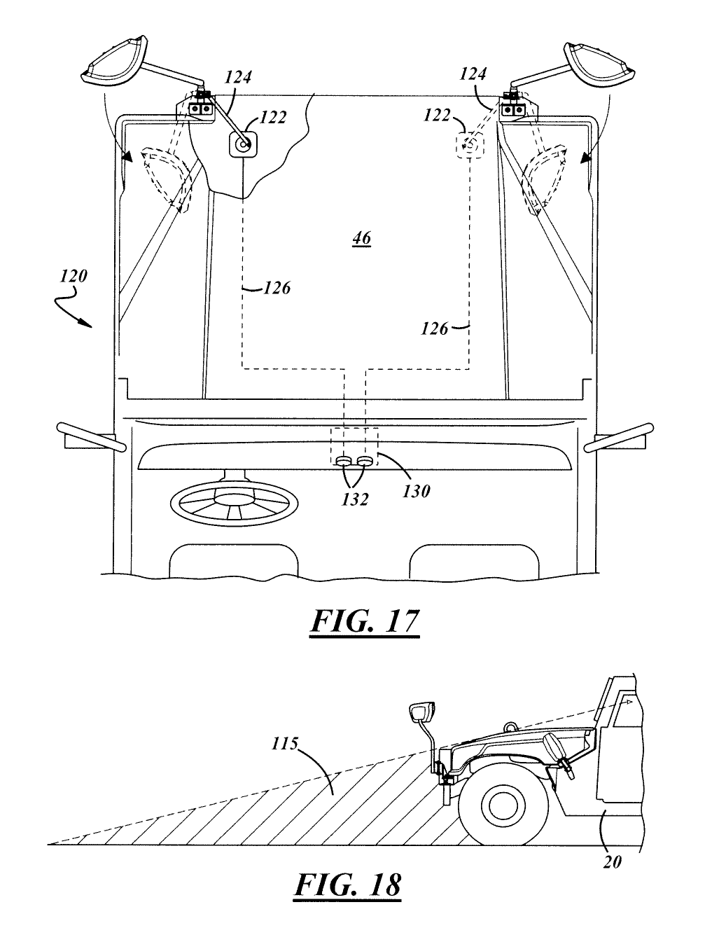

One example of a electromechanical rotation system 120 is shown in FIG. 17. A mechanical mechanism 122 is positioned under the hood 46 of the vehicle or mounted outside it. The mechanism 122 has an activating aim or lever member 124 which, when activated, rotates the imaging systems from one position to another. The mechanical mechanism 122 is shown schematically in FIG. 17 and can be any type of mechanical mechanism which can facilitate rotation of the imaging systems.

The mechanical mechanisms 122 are activated by the driver inside the vehicle 20 by an electrical system 130. The actuation mechanism for the electrical system 130 can be any type of conventional mechanism, such as, for example, a two-position switch or push buttons 132 which are shown in FIG. 17. The system is connected to the mechanism mechanisms 122 by wires or other electrical conduits 126.

Movement of a switch or buttons by the driver or passenger inside the vehicle allows the imaging systems to be rotated remotely between their deployed and stored positions. It is also possible to provide actuation mechanisms which allow rotation of the imaging systems to positions between these two positions.

Similarly, the manner in which the mirror assemblies 26, 28 are attached to the mounting members 30, 32 as shown in FIG. 8 is only a preferred embodiment or manner in which the two components can be secured together. Other mechanisms or methods for securing mirror assemblies to mounting members could be utilized, as are known to persons of ordinary skill in the art.

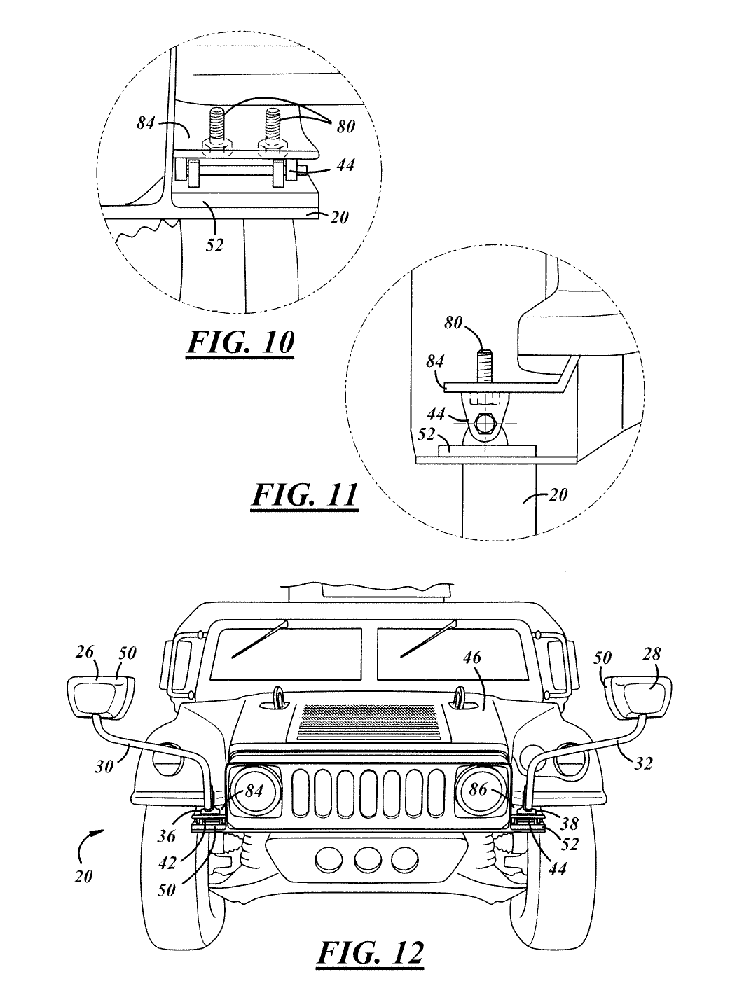

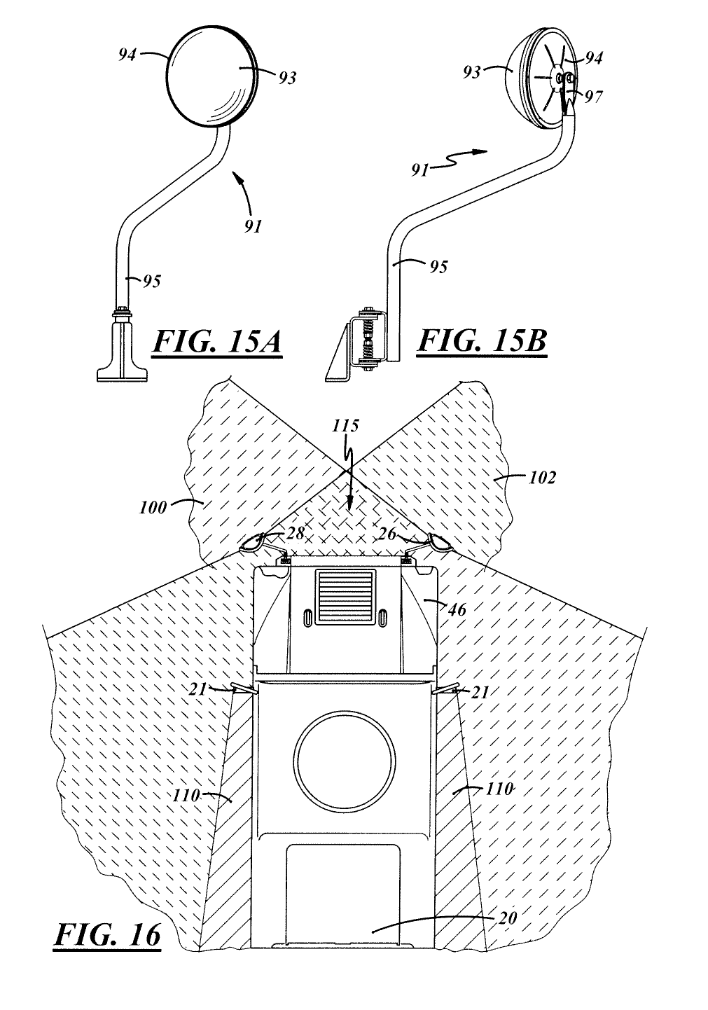

The types of mirror assemblies used with the present invention are not limited to the type as shown in FIGS. 1-13. Two alternate embodiments of mirror assemblies are shown in FIGS. 14A-14B and 15A-15B. The mirror imaging system shown in FIGS. 14A and 14B is indicated by the reference numeral 90. Similarly, the mirror imaging system shown in FIGS. 15A and 15B is indicated by the reference numeral 91. The system 90 includes a mirror assembly 92 that has a convex ellipsoid-shaped mirror lens member 93. The mirror assembly 92 is attached to a mounting mechanism 94 by a mounting mechanism 96.

In FIGS. 15A and 15B, the mirror assembly 94 has a circular configuration with a circular convex mirror lens member 93. The mirror assembly is attached to mounting mechanism 95 by mounting mechanism 97.

As shown, the particular type of mirror assembly utilized with the present invention is not limited to one particular type of mirror assembly. The mirror assembly, however, should provide a field of view for the driver of the vehicle which is significantly enlarged from the field of view that the driver would have with the conventional rear view mirrors on the sides of the vehicle. Conventional rearview mirrors are shown in FIGS. 1 and 2 and identified by the reference numeral 21.

The mirror imaging system in accordance with the present invention is used with the vehicle 20 when the vehicle is stationary or in motion, such as during the driver's regular routine or, upon a special mission or patrol duty. A schematic drawing showing the fields of view for mirror assemblies for use in the present invention is shown in FIG. 16. The mirror assemblies 26, 28 used in the present invention provide fields of view for the driver of the vehicle substantially the same size as the fields of view 100 and 102, respectively, as shown in FIG. 16. In contrast, the fields of view of the rearview mirrors 21 is shown by the areas 110 in FIG. 14.

The triangular shaped area 115 directly in front of the vehicle 20 is one of the hardest areas for the driver to see. The reason for this is schematically shown in FIG. 17. The line of sight of the driver over the hood of the vehicle creates a large blind spot directly in front of the vehicle. With use of the present invention, that blind spot is now visible to the driver, along with the rest of the fields of view 100, 102 as shown in FIG. 16.

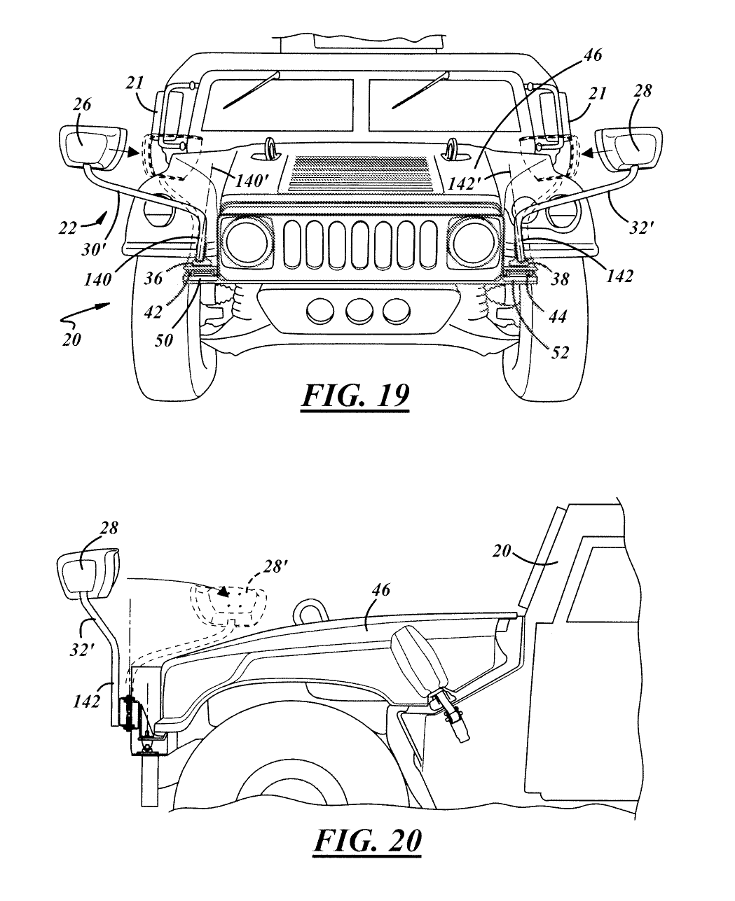

A further embodiment of the invention is shown in FIGS. 19-20. In this embodiment, the mounting assemblies 30′ and 32′ have vertical sections 140 and 142, respectively, which are angled from the perpendicular. This is also shown by the extended centerline 140′ and 142′. By angling the sections 140 and 142 of the mounting assemblies, the mirror assemblies 26 and 28 will lie even closer to the surface of the hood which further minimizes possible direct obstructions to the driver of the vehicle by the imaging systems.

Although the invention has been described with respect to preferred embodiments, it is to be also understood that it is not to be so limited since changes and modifications can be made therein which are within the full scope of this invention as detailed by the following claims.

What is claimed is:

1. A mirror image system for a vehicle, the vehicle having front and rear wheels and having a front hood member which rotates to the open position around a pair of hinge members positioned in the front end of the vehicle forward of the front wheels, said system comprising:
a mirror assembly;
a mounting member; and
a mounting mechanism;
said mirror assembly comprising a housing member and a lens member, said lens member having a convex or ellipsoidal shape providing a wide field of view;
said mounting member having two ends, a first end connected to said mirror assembly and a second end connected to said mounting mechanism;
said mounting mechanism comprising a mounting bracket and a spring activated rotation mechanism, said mounting bracket having mounting openings corresponding to mounting members on a hinge member on a vehicle, said spring activated rotation mechanism selectively allowing rotation of said mounting member and mirror assembly from a first deployed position to a second stored position;
wherein in said first deployed position, said mirror assembly extends outwardly from both the front and sides of a vehicle to provide a wide field of view along the front and sides of the vehicle; and
wherein in said second stored position, said mirror assembly is positioned such that it does not extend beyond the front or sides of the vehicle.

2. The mirror imaging system as described in claim 1 wherein said mounting member is a tubular member.

3. The mirror imaging system as described in claim 1 wherein said mirror imaging system comprises two of said mirror assemblies, two of said mounting members and two of said mounting mechanisms, each one adapted to be positioned on separate hinge members on a vehicle.

4. The mirror imaging system as described in claim 1 wherein said spring activated rotation mechanism comprises a ratcheting mechanism which allows rotation of said mounting member and said mirror assembly at a plurality of discrete locations between said first deployed position and said second stored position.

5. A vehicle having a mirror image system, comprising:
a vehicle, said vehicle having front and rear wheels and having a front hood member which rotates to the open position around a pair of hinge members positioned in the front end of the vehicle forward of the front wheels:
a mirror assembly;
a mounting member; and
a mounting mechanism;
said mirror assembly comprising a housing member and a lens member, said lens member providing a wide field of view;
said mounting member having two ends, a first end connected to said mirror assembly and a second end connected to said mounting mechanism;
said mounting mechanism comprising a mounting bracket and at least one spring activated rotation mechanism, said mounting bracket having mounting openings corresponding to mounting members on a hinge member on the vehicle, said spring activated rotation mechanism selectively allowing rotation of said mounting member and mirror assembly from a first deployed position to a second stored position;
wherein in said first deployed position, said mirror assembly extends outwardly from both the front and at least one side of the vehicle to provide a wide field of view along the front and said at least one side of the vehicle; and
wherein in said second stored position, said mirror assembly is positioned inwardly of the front and said at least one side of the vehicle.

6. The mirror imaging system as described in claim 5 wherein said mounting member is positioned in a non-vertical manner in order to allow storage of the mirror assembly adjacent the front hood member, wherein obstruction of the view of the driver of the vehicle is minimized.

7. The mirror imaging system as described in claim 5 further comprising an electronic remote control system which, when activated, rotates the mounting member and mirror assembly between said deployed position and said stored position.

8. The mirror imaging system as described in claim 7 wherein said electronic control system can be activated from inside the vehicle.

9. The mirror imaging system as described in claim 5 wherein said spring activated rotation mechanism comprises a ratcheting mechanism which allows rotation of said mounting member and said mirror assembly at a plurality of discrete locations between said first deployed position and said second stored position.

10. A mirror image system for a vehicle, the vehicle having front and rear wheels and having a front hood member which rotates to the open position around a pair of hinge members positioned in the front end of the vehicle forward of the front wheels, said system comprising:
a pair of mirror assemblies;
a pair of mounting members; and
a pair of mounting mechanisms;
each of said mirror assemblies comprising a housing member and a lens member, said lens member having a convex or ellipsoidal shape providing a wide field of view;
each of said mounting members having two ends, a first end connected to said mirror assembly and a second end connected to said mounting mechanism;
each of said mounting mechanisms comprising a mounting bracket and a spring activated rotation mechanism, said mounting bracket having mounting openings corresponding to mounting members on a hinge member on a vehicle, said spring activated rotation mechanism selectively allowing rotation of said mounting member and mirror assembly from a first deployed position to a second stored position;
wherein in said first deployed position, each of said mirror assemblies extends outwardly from both the front and sides of a vehicle to provide a wide field of view along the front and sides of the vehicle; and
wherein in said second stored position, each of said mirror assemblies are positioned such that it does not extend beyond the front or sides of the vehicle.

11. The mirror imaging system as described in claim 10 wherein each of said mounting members is a tubular member.

12. The mirror imaging system as described in claim 10 wherein each of said mounting mechanisms is adapted to be positioned on separate hinge members on a vehicle.

13. The mirror imaging system as described in claim 10 wherein each of said spring activated rotation mechanisms comprises a ratcheting mechanism which allows rotation of said mounting member and said mirror assembly at a plurality of discrete locations between said first deployed position and said second stored position.

14. A vehicle having a mirror image system, comprising:
a vehicle, said vehicle having front and rear wheels and having a front hood member which rotates to the open position around a pair of hinge members positioned in the front end of the vehicle forward of the front wheels:
a pair of mirror assemblies;
a pair mounting members; and
a pair of mounting mechanisms;
each of said mirror assemblies comprising a housing member and a lens member, said lens member providing a wide field of view;
each of said mounting members having two ends, a first end connected to said mirror assembly and a second end connected to said mounting mechanism;
each of said mounting mechanisms comprising a mounting bracket and at least one spring activated rotation mechanism, said mounting bracket having mounting openings corresponding to mounting members on a hinge member on the vehicle, said spring activated rotation mechanism selectively allowing rotation of said mounting member and mirror assembly from a first deployed position to a second stored position;
wherein in said first deployed position, each of said mirror assemblies extends outwardly from both the front and at least one sides of the vehicle to provide a wide field of view along the front and said at least one side of the vehicle; and
wherein in said second stored position, each of said mirror assemblies are positioned inwardly of the front and said at least one side of the vehicle.

15. The mirror imaging system as described in claim 14 wherein said mounting member is a tubular member.

16. The mirror imaging system as described in claim 14 wherein each of said mounting mechanisms, is adapted to be positioned on separate hinge members on a vehicle.

17. The mirror imaging system as described in claim 14 wherein each of said spring activated rotation mechanisms comprises a ratcheting mechanism which allows rotation of said mounting member and said mirror assembly at a plurality of discrete locations between said first deployed position and said second stored position.

18. The mirror imaging system as described in claim 14 wherein said mounting member is positioned in a non-vertical manner in order to allow storage of the mirror assembly adjacent the front hood member, wherein obstruction of the view of the driver of the vehicle is minimized.

19. The mirror imaging system as described in claim 14 further comprising an electronic remote control system which, when activated, rotates the mounting member and mirror assembly between said deployed position and said stored position.

20. The mirror imaging system as described in claim 19 wherein said electronic control system can be activated from inside the vehicle.
